(19) United States
(12) Patent Application Publication
(10) Pub. No.: US 2008/0037978 A1
(43) Pub. Date: Feb. 14, 2008

(54) SINGLE-LENS REFLEX CAMERA

(76) Inventor: Sigeru IWASE, Tokyo (JP)

Correspondence Address: OSTROLENK FABER GERB & SOFFEN, 1180 AVENUE OF THE AMERICAS, NEW YORK, NY, 100368403, US

(21) Appl. No.: 11/836,524

(22) Filed: Aug. 9, 2007

(30) Foreign Application Priority Data
Aug. 10, 2006 (JP) 2006-217899

(51) Int. Cl. G03B 15/03; G03B 19/12

(52) U.S. Cl. 396/155; 396/358

(57) ABSTRACT

The present invention discloses a single-lens reflex camera configured such that, upon viewing a subject image through a finder optical system, a movable reflecting mirror reflects the optical axis of a light beam from a shooting optical system at an obtuse angle to guide the light beam to an optical element such as a pentamirror or a pentaprism. According to the present invention, since the light beam from the shooting optical system is reflected at the obtuse angle by the movable reflecting mirror, the overall pentagonal section as a reflective member, for example, for guiding a viewing image to an eyepiece optical system is arranged on a more rear side than that in such a structure that the light beam is reflected at right angles. This configuration of the invention can result in a reduction in camera size in the direction of the shooting optical path.

### CROSS-REFERENCE TO RELATED APPLICATION

This application is based upon and claims the benefit of priority from prior Japanese Patent Application No. 2006-217899, filed on Aug. 10, 2006, the entire contents of which are incorporated herein by reference.

### BACKGROUND OF THE INVENTION

1. Field of the Invention

The present invention relates to a single-lens reflex camera and more particularly to the arrangement of a finder optical system in the single-lens reflex camera.

2. Description of the Related Art

In general, in a single-lens reflex camera, a subject light beam passing through a shooting optical system is reflected upward by a movable reflecting mirror (main mirror) on an optical axis and imaged on a focusing screen. Then, the image (inverted image) is converted into an erect image through a pentaprism (or a pentamirror) located above the focusing screen, allowing users to view the erect subject image through an eyepiece optical system located behind the pentaprism.

Thus, the focusing screen and the pentaprism are located above the reflecting mirror on the optical axis of the shooting optical system, and the eyepiece optical system is located behind the pentaprism. Therefore, significant space is required above the movable reflecting mirror where the pentaprism is located.

In a conventional arrangement, the light beam passing through the shooting optical system is reflected at right angle by the movable reflecting mirror and imaged on the focusing screen. In this case, the optical axis of the reflected light beam from the reflecting mirror is orthogonal to the optical axis of the shooting optical system (for example, see Japanese Patent Application Laid-Open No. 2000-194052).

On the other hand, Japanese Patent Application Laid-Open No. 11-352582 discloses a structure in which the light beam passing through the shooting optical system is reflected at an acute angle by the movable reflecting mirror and enters into a pentaprism so that the optical axis of the eyepiece optical system inclines with respect to the optical axis of the shooting optical system. In this structure, the optical axis of the reflected light beam from the reflecting mirror intersects the optical axis of the shooting optical system at the acute angle and the pentaprism is arranged in more forwardly advanced position compared with the case of 2000-194052.

### BRIEF SUMMARY OF THE INVENTION

The single-lens reflex camera of the present invention is configured such that, upon viewing a subject image through a finder optical system, a movable reflecting mirror reflects the optical axis of a light beam from a shooting optical system at an obtuse angle to guide the light beam to an optical element such as a pentamirror or a pentaprism.

An exemplary structure of the present invention can be expressed as a single-lens reflex camera comprising: an eyepiece optical system having an optical axis on a plane including the optical axis of a shooting optical system and located behind the shooting optical system; a movable reflecting mirror for reflecting the optical axis of the shooting optical system at an obtuse angle with respect to the same optical axis on the plane to cause the optical axis of the shooting optical system to intersect the optical axis of the eyepiece optical system in a nonorthogonal manner; a focusing screen orthogonal to the optical axis of the shooting optical system reflected by the reflecting mirror to form thereon a viewing image of a subject from a subject light beam reflected by the reflecting mirror; and a reflective member having a pair of roof faces for horizontally flipping the viewing image on the focusing screen and reflecting the light beam of the viewing image toward the front of the eyepiece optical system, and a reflective face arranged in front of the eyepiece optical system to reflect the viewing image reflected by the roof faces toward the eyepiece optical system.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a perspective view of a single-lens reflex camera according to one preferred embodiment of the present invention;

FIG. 2 is a longitudinal sectional view of the single-lens reflex camera taken along line A-A in FIG. 1; and

FIG. 3 is a transverse sectional view of the single-lens reflex camera taken along line B-B in FIG. 1.

### DETAILED DESCRIPTION OF THE PREFERRED EMBODIMENT

A preferred embodiment of the invention is described below with reference to the accompanying drawings.

In the embodiment, a movable reflecting mirror is arranged to reflect a light beam from a shooting optical system to form an obtuse angle with respect to the optical axis of the shooting optical system. For example, in the embodiment, a focusing screen is arranged above the reflecting mirror in such an inclined state that one side thereof on the subject side is placed a bit further away from the optical axis of the shooting optical system than the other side. Further, the focusing screen is located to be orthogonal to the optical axis of the shooting optical system reflected by the reflecting mirror.

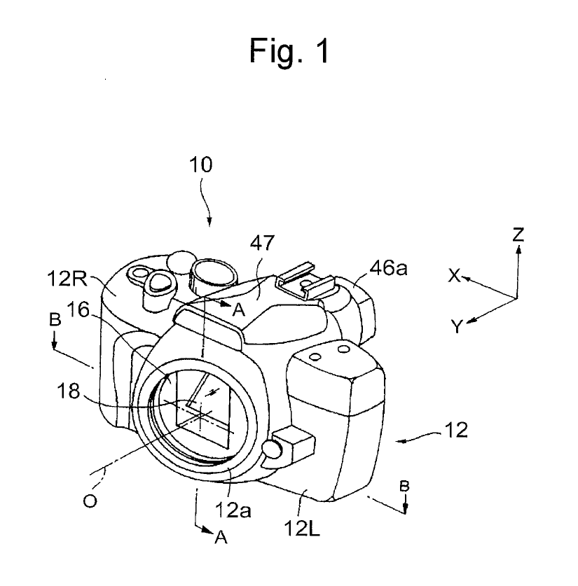

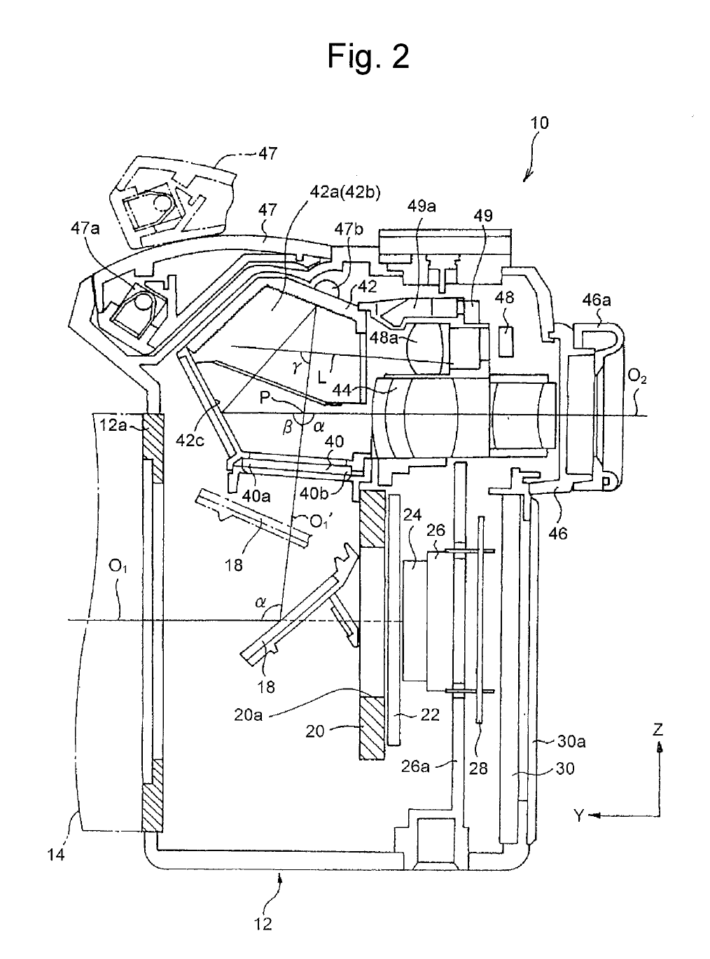

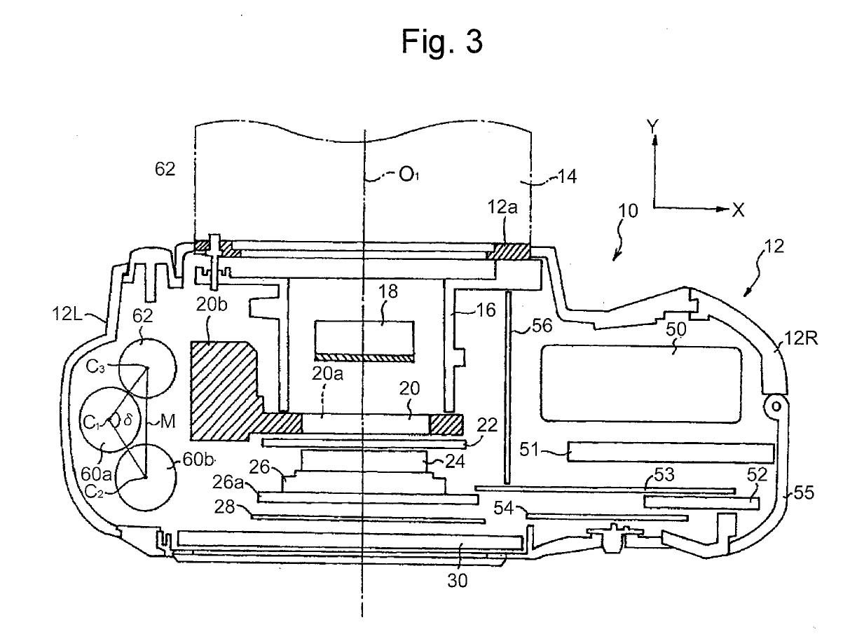

FIG. 1 is a perspective view of a single-lens reflex camera according to one preferred embodiment of the present invention, FIG. 2 is a longitudinal sectional view of the single-lens reflex camera taken along section line A-A in FIG. 1, and FIG. 3 is a transverse sectional view of the single-lens reflex camera taken along section line B-B in FIG. 1. In this figure, hatching indicating the cross section is kept to a minimum for brevity.

The arrangement of main components in a single-lens reflex camera (camera) 10 will be schematically described below with reference to FIGS. 1 to 3, mainly to FIG. 2. A shooting optical system 14 is removably mounted on a body mount 12a of a camera body 12 through a lens mount (not shown). A mirror box 16 is located behind the optical axis of the body mount 12a in the camera body 12. A movable reflecting mirror 18 is arranged in the mirror box 16 to be movable between a reflecting position (indicated by a solid line), at which it is located on an optical axis O1 of the shooting optical system to reflect a subject light beam from the shooting optical system, and a retracted position (indicated by an alternate long and short dash line) retracted from the optical axis O1.

A shutter device 20, a dust-proof device 22, a low-pass filter 24, an image pickup device 26 such as a CCD, an electric circuit board 28, an liquid crystal display (LCD) 30, etc. are arranged behind the reflecting mirror 18 along the optical axis O1 of the shooting optical system. When the reflecting mirror 18 is at the retracted position retracted from the optical axis O1 of the shooting optical system, the light beam from the shooting optical system 14 passes through an exposure opening 20a of the shutter device 20, and after high frequency components of the light beam are removed by the low-pass filter 24, the light beam enters the image pickup device 26 at right angles to the imaging surface of the image pickup device 26 so that an image is formed thereon and subjected to photoelectric conversion to generate a photoelectrically converted image signal. The electric circuit board 28 digitizes and processes the image signal photoelectrically converted by the image pickup device 26. On the liquid crystal display (LCD) 30, not only is the image signal from the image pickup device 26 displayed as a live-view image, but also an image signal recorded on a recording medium is decompressed and displayed upon playback. The liquid crystal display (LCD) 30 is protected by a display window 30a made of an acrylic plate or the like fitted in a window opening of the camera body 12. The dust-proof device 22 generates ultrasonic wave vibration to prevent dust from sticking to the image pickup device 26 on a fixing plate 26a.

A focusing screen 40 is arranged above the reflecting mirror 18 at a position optically equivalent to the position of the image pickup device 26 located along the optical axis O1 of the shooting optical system. The light beam (subject light beam) passing through the shooting optical system 14 and reflected upward by the reflecting mirror 18 is focused to form a subject image on the focusing screen. Here, the reflecting mirror 18 is so arranged to reflect the light beam from the shooting optical system 14 at an obtuse angle (reflection angle α>90 degrees) when it is at the reflecting position. The focusing screen 40 is a quadrangular acrylic plate member. The focusing screen 40 is so arranged that one side (front end portion) 40a on the subject side is placed a bit further away from the optical axis O1 of the shooting optical system than the other side (rear end portion) 40b, i.e., it is inclined with respect to the optical axis O1 with the one side higher than the other. Further, the focusing screen 40 is orthogonal to an optical axis O1′ of the light beam reflected by the reflecting mirror 18.

A reflective member 42 as reflecting means such as a pentamirror or a pentaprism is provided above the focusing screen 40. The subject image formed on the focusing screen 40 is reflected, for example, by the pentamirror (reflective member) 42 and magnified through an eyepiece optical system 44 located behind the pentamirror 42, allowing the user to view the subject image through a finder 46. An eye cup 46a made of rubber is attached to the finder 46.

In an imaging ready state, the eyepiece optical system 44 is located behind the shooting optical system 14 in such a manner that an optical axis O2 of the eyepiece optical system is parallel to the optical axis O1 of the shooting optical system in a plane including the optical axis O1 of the shooting optical system (e.g., in plane YZ in FIG. 2). As mentioned above, since the reflecting mirror 18 reflects the light beam from the shooting optical system at the obtuse angle (reflection angle α>90 degrees) with respect to the optical axis O1, the light beam from the reflecting mirror 18 is not orthogonal to the optical axis O2 of the eyepiece optical system. In other words, the optical axis O1′ of the light beam reflected by the reflecting mirror 18 intersects the optical axis O2 of the eyepiece optical system in a nonorthogonal manner.

Further, a line segment of the optical axis O1′ as the reflected optical axis from the reflecting mirror 18 to an intersecting point P at which the optical axis O1′ as the reflected optical axis intersects the optical axis O2 of the eyepiece optical system forms the same angle as the obtuse angle α at the intersecting point P with a line segment of the optical axis O2 from the point P to the backside of the camera in the eyepiece optical system. Further, an angle β supplementary to the angle α is an acute angle (β<90 degrees).

The pentamirror 42 as the reflective member is located in front of the eyepiece optical system 44 above the reflecting mirror 18. The pentamirror 42 has three reflective faces, namely a pair of roof faces (first and second reflective faces) 42a, 42b, and a third reflective face 42c. The pair of roof faces 42a, 42b angled toward each other to meet at an angle of 90 degrees are located above the reflecting mirror 18 to face the reflecting mirror 18. The third reflective face 42c is located in front of the eyepiece optical system 44 to face the eyepiece optical system.

Further, an angle between the line of intersection (ridge line) of the roof faces and the extended line of the third reflective face 42c is determined by a simple geometric calculation as β/2, i.e., 90 degrees−α/2. As in the embodiment, when the optical axis O1 of the shooting optical system 14 is arranged in parallel to the optical axis O2 of the eyepiece optical system 44, the pentamirror 42 is configured to have the above-mentioned angular relationship.

The light beam is reflected upward by the reflecting mirror 18 and focused to form an image on the focusing screen 40. The light beam (imaged light beam) from the focusing screen 40 is reversed left-to-right as a result of being reflected by the pair of roof faces 42a, 42b of the pentamirror, and the light beam reflected by the roof faces is further reflected by the third reflective face 42c. The light beam reflected by the third reflective face 42c enters the eyepiece optical system 44, allowing the user to view an erect image through the finder 46. In other words, the pair of roof faces 42a, 42b horizontally flips (reverses) the light beam in line symmetry with respect to a line (line L in FIG. 2 with intersection angle γ of 90 degrees). The line L is orthogonal to the optical axis O1′ of the light beam reflected on the reflecting mirror 18. The third reflective face 42c reflects the imaged light beam reversed left-to-right by the roof faces 42a, 42b toward the eyepiece optical system 44.

Thus, the reflecting mirror 18, the focusing screen 40, the pentamirror 42 as the reflective member, and the eyepiece optical system 44 constitute a finder optical system of the single-lens reflex camera 10.

Here, since the optical axis O1′ of the light beam reflected by the reflecting mirror 18 is reflected through the pentamirror 42 in a direction parallel to the optical axis O1 of the shooting optical system, the optical axis O2 of the eyepiece optical system is parallel to the optical axis O1 of the shooting optical system.

A flash device (flash member) 47 as a flash unit is arranged in the camera body 12 diagonally to the front of the pentamirror 42 corresponding to the subject side along the optical axis direction of the shooting optical system. This flash device 47 has a flash firing part 47a including a flashlight emitter, a flashlight reflector, etc. The flash device 47 is attached to a rotating shaft 47b arranged in an upper portion of the camera body near the top surface of the roof faces of the pentamirror 42 in such a manner to be rotatable between a firing position (indicated by an alternate long and short dash line) exposed from the camera body 12 and a non-firing position (indicated by a solid line) housed in the camera body.

As mentioned above, the single-lens reflex camera 10 of the embodiment is configured such that the light beam from the shooting optical system 14 is reflected by the movable reflecting mirror 18 at an obtuse angle with respect to the optical axis O1 of the shooting optical system. The pentamirror 42 is arranged closer to the eyepiece optical system 44, i.e., on a more rear side, than that in such a structure that the light beam is reflected at right angles, and this results in a more space in front of the pentamirror.

Therefore, a long distance is not required in the optical axis direction of the eyepiece optical system, enabling a reduction in the size of the single-lens reflex camera 10. Further, the optical axis O2 of the eyepiece optical system is positioned in parallel to the optical axis O1 of the shooting optical system on the same plane (YZ plane in FIG. 2), and this structure does not force the user to look through the finder from an unnatural direction. Further, the rear face of the camera body 12 does not need to be formed into an inclined plane, enabling a flat rear shape.

In addition, the pentamirror (reflective member) 42 is not located on the front side, and this makes it easy to secure enough space for the flash device 47 diagonally in front of the pentamirror. The reduction in the size of the camera 10 is also possible in this regard.

In the embodiment, the pentamirror is used in the finder optical system of the single-lens reflex camera, but a normal pentaprism can also be used instead.

A photometric element 48 for measuring an exposure value of the subject image and a light-metering optical system 48a for guiding a light beam to the photometric element are arranged above the eyepiece optical system 44, and a light-emitting element 49 used for focusing of the subject image on the focusing screen and a display optical system 49a therefor are arranged above the light-metering optical system 48a.

Further, as shown in FIG. 3, a battery 50 is housed in a right-hand portion (grip portion) 12R of the camera body 12 as viewed from the user side toward the subject side along the optical axis 01 of the shooting optical system, and electric circuit boards 53, 54 for a first recording medium 51 such as a CF card and a second recording medium 52 such as an xD-Picture Card (TM), respectively, are arranged behind the battery in the longitudinal direction. The components such as the battery 50 are disposed in the longitudinal direction (in a direction perpendicular to the paper surface) unless otherwise indicated. Here, slots for recording media 51, 52 are covered by a slot cover 55 capable of being opened and closed, and the slot cover forms part of the outer surface of the camera body. Further, an electric circuit board 56 is arranged between the mirror box 16 and the battery 50.

The following is a brief description of the functions of the electric circuit boards 53, 54, and 56. For example, the electric circuit board 53 corresponds to a main circuit board on which a CPU for controlling all the electric circuit systems in the camera 10 is mounted. Signals from various switches provided in the camera body 12 are input into the electric circuit board 54. Further, the electric circuit board 56 is a power supply circuit board for conversion of voltage from the battery 50 to stabilize the voltage and supply of the stabilized voltage to each board and the like.

The shutter device 20 located between the reflecting mirror 18 and the dust-proof device 22 has a shutter mechanism driving part 20b including shutter blades and drive means for moving the blades. The shutter mechanism driving part 20b is arranged at a lateral side of the exposure opening 20a on the opposite side (in a left-hand portion of the camera body) 12L of the grip portion 12R across the optical axis O1 of the shooting optical system.

In addition to the shutter mechanism driving part 20b, a pair of capacitors 60a, 60b for flash firing, and a motor 62 for shutter driving are arranged in the left-hand portion 12L of the camera body.

The pair of capacitors 60a, 60b, and the motor 62 for shutter driving are formed into a vertically long cylinder shape, respectively. The pair of capacitors are arranged relative to the shutter mechanism driving part 20b in the longitudinal direction along the lateral side of the shutter mechanism driving part 20b, and the motor is arranged in parallel to the capacitors in the longitudinal direction at the lateral side of the shutter mechanism driving part 20b.

In cross section (XY section in FIG. 3) perpendicular to the longitudinal direction of the pair of capacitors 60a, 60b (i.e., Z direction in FIG. 3 as the direction perpendicular to the paper surface), if a center of the capacitors 60a, 60b are expressed as C1 and C2, and the center of the motor 62 is expressed as C3, the three centroids C1, C2, and C3 forms a triangle. In the triangle, one of the three vertex angles is an obtuse angle (vertex angle δ>90 degrees) and one side M opposite to the obtuse angle is positioned along the shutter mechanism driving part 20b. For example, the pair of capacitors 60a, 60b, and the motor 62 are so arranged that the opposite side M is substantially parallel to the shutter mechanism driving part 20b.

In general, since components fewer than those in the grip portion are arranged on the opposite side (left-hand portion of the camera body) 12L of the grip portion, there is sufficient space compared to the grip portion. Therefore, if the pair of capacitors 60a, 60b, and the motor 62 are arranged as mentioned above in view of the arrangement relative to the shutter mechanism driving part 20b and their mutual arrangement, the space can be used effectively, making the layout easy without increase in camera size. In other words, the effective use of space can result in a reduction in the size of the single-lens reflex camera 10.

Further, the pair of capacitors 60a, 60b are used instead of use of a single large-capacity capacitor. This makes possible a variety of layouts, and hence various layouts are made selectable.

The aforementioned embodiment is merely illustrative and not limitative of the scope of the invention. It should be noted that any modification or change can be included in the present invention as long as it does not depart from the technical scope of the invention.

For example, the focusing screen can be omitted because the subject image formed on the focusing screen 40 can be optically captured without the focusing screen.

While there has been shown and described what is considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A single-lens reflex camera comprising:
an eyepiece optical system having an optical axis on a plane including an optical axis of a shooting optical system and located behind the shooting optical system;
a movable reflecting mirror for reflecting the optical axis of the shooting optical system at an obtuse angle with respect to the same optical axis on the plane to cause the optical axis of the shooting optical system to intersect the optical axis of the eyepiece optical system in a nonorthogonal manner;
a focusing screen orthogonal to the optical axis of the shooting optical system reflected by the reflecting mirror to form thereon a viewing image of a subject from a subject light beam reflected by the reflecting mirror; and
a reflective member having a pair of roof faces for horizontally flipping the viewing image on the focusing screen and reflecting the light beam of the viewing image toward the front of the eyepiece optical system, and a reflective face arranged in front of the eyepiece optical system to reflect the viewing image reflected by the roof faces toward the eyepiece optical system.

2. The single-lens reflex camera according to claim 1, further comprising
a flash unit having a flash firing part movable between a firing position and a non-firing position, the flash firing part being located in front of the reflective member in the optical axis direction when the flash firing part is at the non-firing position.

3. The single-lens reflex camera according to claim 1, wherein the optical axis of the eyepiece optical system is parallel to the optical axis of the shooting optical system.

4. The single-lens reflex camera according to claim 2, wherein the optical axis of the eyepiece optical system is parallel to the optical axis of the shooting optical system.

5. The single-lens reflex camera according to claim 1, wherein the reflective member is constructed of a plurality of mirrors.

6. A single-lens reflex camera comprising:
an eyepiece optical system having an optical axis on a plane including an optical axis of a shooting optical system and located behind the shooting optical system;
a movable reflecting mirror for reflecting the optical axis of the shooting optical system at an obtuse angle with the same optical axis on the plane to cause the optical axis of the shooting optical system to intersect the optical axis of the eyepiece optical system in a nonorthogonal manner;
a focusing screen orthogonal to the optical axis of the shooting optical system reflected by the reflecting mirror to form thereon a viewing image of a subject from a subject light beam reflected by the reflecting mirror; and
reflecting means having a pair of roof faces for horizontally flipping the viewing image on the focusing screen and reflecting the light beam of the viewing image toward the front of the eyepiece optical system, and a reflective face arranged in front of the eyepiece optical system to reflect the viewing image reflected by the roof faces toward the eyepiece optical system.

7. The single-lens reflex camera according to claim 6, further comprising
flash means having a flash firing part movable between a firing position and a non-firing position, the flash firing part being located in front of the reflecting means in the optical axis direction when the flash firing part is at the non-firing position.

8. The single-lens reflex camera according to claim 6, wherein the optical axis of the eyepiece optical system is parallel to the optical axis of the shooting optical system.

9. The single-lens reflex camera according to claim 7, wherein the optical axis of the eyepiece optical system is parallel to the optical axis of the shooting optical system.

10. The single-lens reflex camera according to claim 6, wherein the reflecting means is constructed of a plurality of mirrors.

11. A single-lens reflex camera that reflects a light bean from a subject on a movable reflecting mirror, forms an image on a focusing screen, and has a reflecting means for reflecting the light flux of the formed image towards an eyepiece optical system to make the image upright, wherein
the reflecting mirror is arranged to reflect the light beam from the shooting optical system at an obtuse angle with respect to the optical axis of the shooting optical system, and
the focusing screen is orthogonal to an optical axis of the light beam reflected by the reflecting mirror.

12. The single-lens reflex camera according to claim 11, further comprising
flash means having a flash firing part movable between a firing position and a non-firing position, the flash firing part being located in front of the reflecting means in the optical axis direction when the flash firing part is at the non-firing position.

13. The single-lens reflex camera according to claim 11, wherein the optical axis of the eyepiece optical system is parallel to the optical axis of the shooting optical system.

14. The single-lens reflex camera according to claim 12, wherein the optical axis of the eyepiece optical system is parallel to the optical axis of the shooting optical system.

15. The single-lens reflex camera according to claim 11, wherein the reflecting means is constructed of a plurality of mirrors.
